(19) United States
(12) Patent Application Publication
(10) Pub. No.: US 2006/0002729 A1
(43) Pub. Date: Jan. 5, 2006

(54) Image forming apparatus with reduced printing time

(75) Inventors: Ken Yoshizuka, Nagano-ken (JP); Keiichi Taguchi, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/132,452

(22) Filed: May 19, 2005

(30) Foreign Application Priority Data
May 20, 2004 (JP) 2004-150454

(51) Int. Cl. G03G 15/06

(52) U.S. Cl. 399/55

(57) ABSTRACT

An image forming apparatus comprises an image supporting body in which a latent image is formed, a developing device which is mounted detachably with a plurality of developing units storing developers of the same color and which can move the developing units to a plurality of positions, and control unit for controlling a printing operation for adhering the developer of the developing unit on a development position onto a latent image of the image supporting body to perform development in response to a print request. Further, after finishing the printing operation using a first developing unit in accordance with a print job, or at the time of starting up the power or of predetermined initialization, the control unit moves a second developing unit used in the next print job to a specified queue position among the plurality of positions, to maintain the second developing unit in a queuing state.

### BACKGROUND OF THE INVENTION

1. Field of the Invention

The present invention relates to an image forming apparatus for forming an image by using an electronic printing technology or the like, and particularly to an image forming apparatus which has a plurality of developing units for storing developers of the same color, and which can move a developing unit to be used for the next print request to a specified queue position after a printing operation is finished, and reduce the printing time taken for the next print request.

2. Description of the Related Art

An image forming apparatus which forms an image by using an electronic printing technology is provided in a printer, facsimile, copier and the like, and comprises an image supporting body (photoconductor drum) in which an electrostatic latent image is formed in accordance with image data, a charging unit for charging an external surface of the image supporting body, an exposure unit for exposing the external surface of the charged image supporting body in accordance with the image data to form the electrostatic latent image, a developing device for feeding a toner as a developer to the image supporting body to develop the electrostatic latent image of the image supporting body into a toner image, and a transfer unit for transferring the toner image to a medium as a target for transfer. The developing device detachably holds the developing units containing a plurality of color toners or toners of the same color, and brings an appropriate developing unit proximate to the image supporting body in accordance with the developing timing. The developing device therefore has a developing rotary which is subjected to rotation control. When performing color printing, a plurality of color toners, e.g. four colors of developing units (yellow Y, magenta M, cyan C, and black K), are mounted on the developing rotary, and these developing units are rotationally moved so as to be sequentially brought proximate to the image supporting body, and development of each color is carried out.

On the other hand, there has been suggested to mount the plurality of developing units of the same color all together, e.g. black, on the developing rotary of the developing device to obtain an image forming apparatus for black-and-white printing. Examples are shown in Japanese Patent Application Laid-Open Nos. 2002-351190 (published on Dec. 4, 2002) and 2003-316106 (published on Nov. 6, 2003). In this image forming apparatus for black-and-white printing, a plurality of black developing units can be mounted, thus, even when performing a large amount of black-and-white printing, frequency of replacing the developing units can be reduced by sequentially using the plurality of developing units. Specifically, printing is repeated using one black developing unit, and when there is no longer a remaining developer, the developing unit is switched to another developing unit to repeat the printing. Furthermore, when there is no developer remaining in all of the developing units, the developing units are replaced.

### SUMMARY OF THE INVENTION

In the case where a plurality of developing units of the same color are used by sequentially replacing them, it is often preferred to execute a printing operation after selecting any developing unit for a print job. For example, the plurality of developing units may be used by sequentially switching them in order to keep them in an optimum condition, or they may be used by sequentially switching them for other reasons. In this case, if the developing unit as a target for use is rotationally moved to a development position in response to a print request, it requires a time for rotating a developing rotary after the print request is outputted, thereby causing a problem in which the printing time becomes long. Particularly, if the queue position of the developing rotary is fixed, the amount of rotation of the developing rotary becomes large depending on the position of the selected developing unit when the developing units are used by switching them, thereby causing a problem in which the printing time becomes extremely long.

An object of the present invention therefore is to provide an image forming apparatus which can reduce the printing time while switching the developing units to carry out printing.

In order to achieve the above object, according to a first aspect of the present invention, an image forming apparatus comprises an image supporting body in which a latent image is formed, a developing device which is mounted detachably with a plurality of developing units storing developers of the same color and which can move the developing units to a plurality of positions, and control unit for controlling a printing operation for adhering the developer of the developing unit on a development position onto a latent image of the image supporting body to perform development in response to a print request. Further, after finishing the printing operation using a first developing unit in accordance with a print job, or at the time of starting up the power or of predetermined initialization, the control unit moves a second developing unit used in the next print job to a specified queue position among the plurality of positions, to maintain the second developing unit in a queuing state. Since the second developing unit to be used in the next print job is moved to the specified position in the queuing state for the next print job, the printing operation can be started by moving the second developing unit without moving the position thereof significantly, in response to the print request corresponding to the next print job.

In a preferred embodiment of the above-described first aspect, the specified queue position is the development position or a queue position which is most proximate the development position. Since the second developing unit to be used in the next print job queues in the position which is most proximate to the development position, the second developing unit can be moved to the development position in the shortest amount of time in response to a print request, whereby the printing time can be reduced.

In a more preferred embodiment of the above-described first aspect, the specified queue position is a position in which a developer stored in the second developing unit is stirred. Since the second developing unit to be used in the next print job queues in the position where the developer therein is stirred, the second developing unit can be moved to the development position in the sate where the developer is optimum, without moving the position of the second developing unit significantly, in response to the print request corresponding to the next print job.

In order to achieve the above object, a second aspect of the present invention is an image forming apparatus, comprising an image supporting body in which a latent image is formed, a developing device which is mounted detachably with a plurality of developing units storing developers of the same color and which can move the developing units to a plurality of positions, and control unit for controlling a printing operation for adhering the developer of the developing unit on a development position onto a latent image of the image supporting body to perform development in response to a print request, wherein, after finishing the printing operation using a first developing unit in accordance with a print job, the control unit moves a second developing unit used in the next print job to a specified queue position among the plurality of positions, to maintain the second developing unit in a queuing state.

In order to achieve the above object, a third aspect of the present invention is an image forming apparatus, comprising an image supporting body in which a latent image is formed, a developing device which is mounted detachably with a plurality of developing units storing developers of the same color and which can move the developing units to a plurality of positions, and control unit for controlling a printing operation for adhering the developer of the developing unit on a development position onto a latent image of the image supporting body to perform development in response to a print request, wherein, in an initializing operation at the time of turning on the power or of predetermined initialization, the control unit moves a second developing unit used in the next print job to a specified queue position among the plurality of positions, to maintain the second developing unit in a queuing state.

“At the time of predetermined initialization” includes, for example, calibration performed when the photoconductor drum is replaced, in which a pattern of patches is used for optimizing an exposure strength or a charge bias potential for each developing unit, calibration performed when any of the developing units is replaced or newly mounted, and the like. The developing device is rotated due to the calibration processing, thus a developing unit to be used in the next print job is moved to a specified queue position after the calibration processing is ended.

### BRIEF DESCRIPTION OF THE DRAWINGS

FIG. 1 is a main configuration diagram of the image forming apparatus according to the present embodiment;

FIGS. 2A and 2B are a cross sectional views showing a detailed structure of a developing device 50;

FIG. 3 is a block diagram of a control unit 100 according to the present embodiment;

FIG. 4 is a figure showing a development position of the developing device 50 (developing rotary);

FIG. 5 is a figure showing a first queue position of the developing device 50 (developing rotary);

FIG. 6 is a figure showing a second queue position of the developing device 50 (developing rotary);

FIG. 7 is a flow chart showing a control process of the image forming apparatus in the present embodiment; and

FIG. 8 is a figure showing information stored in a nonvolatile memory.

### DESCRIPTION OF THE PREFERRED EMBODIMENTS

Hereinbelow, embodiments of the present invention are described with reference to the drawings. However, the technical scope of the present invention is not limited to these embodiments, but ranges to the items described in the claims and the equivalents thereof.

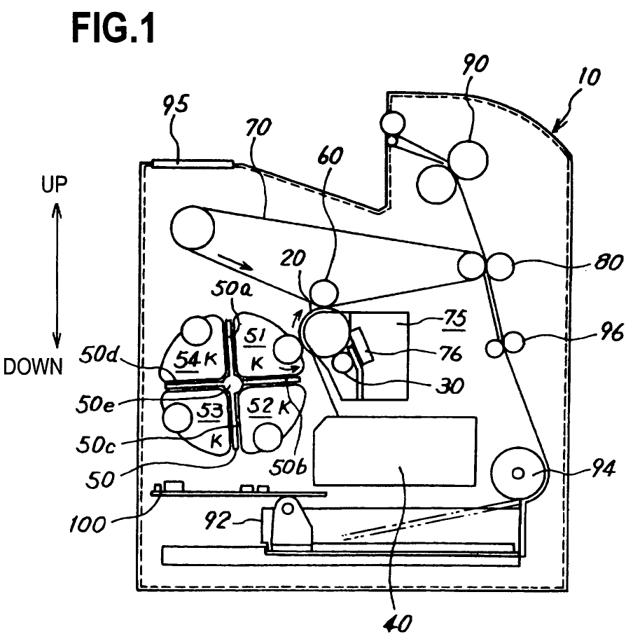

FIG. 1 is a main configuration diagram of the image forming apparatus according to the present embodiment. In the present embodiment, a laser-beam printer 10 is used as an example of the image forming apparatus. A printer 10 in FIG. 1 shows a configuration of a black-and-white print mode.

The printer 10 comprises a charging unit 30, exposure unit 40, developing device 50, primary transfer unit 60, intermediate transfer body 70, and cleaning unit 75, along a rotation direction of a photoconductor drum 20 which is an image supporting body for supporting a latent image. Further, the printer 10 comprises a secondary transfer unit 80, fixing unit 90, display unit 95 for outputting various information items to a user, and a control unit 100 for controlling these units.

The photoconductor drum 20 has a cylindrical conductive substrate and a photosensitive layer formed on an external surface thereof, can be rotated with respect to the central axis, and is rotated clockwise as shown by the arrow. The charging unit 30 evenly charges the external surface of the photoconductor drum 20. The exposure unit 40 irradiates the charged photoconductor drum 20 with an illuminant beam, such as a built-in laser, LED array, or the like, to form an electrostatic latent image. Beam irradiation of the exposure unit 40 is controlled by a driving signal which is modulated based on image information inputted from a host computer.

The developing device 50 is a developing rotary which can be rotated with respect to a central axis 50e, and mount portions 50a to 50d thereof are detachably mounted with developing units 51 to 54 containing toners as developers. The developing device 50 is rotated to move any of the necessary developing units 51 to 54 to a developing position proximate to the photoconductor drum 20, and charged developers are fed to the photoconductor drum 20 by means of the bias potential difference between the developing unit and the image supporting body, whereby the latent image is developed to an image obtained by the developers.

In the example of FIG. 1, the developing units 51 to 54 containing black developers only are mounted on the mount portions 50a to 50d of the developing device 50, and the print mode is black-and-white print mode. In a black-and-white printing process, development is carried out using a developer of the any four developing units. Further, if developing units, each of which contains a developer of black K, cyan C, magenta M, and yellow Y, are mounted on the mount portions 50a to 50d of the developing device 50, the print mode is a color print mode. In a color printing process, formation of a latent image and development using each developer are performed on the photoconductor drum 20 in the order of CMYK. Therefore, the developing device 50 is rotated clockwise to move an appropriate color of developing unit to the developing position proximate to the photoconductor drum 20 to sequentially perform development for every latent image formation and development process of each color.

The primary transfer unit 60 transfers a toner image formed on the photoconductor drum 20 to the intermediate transfer body 70. The intermediate transfer body 70 is an endless belt obtained by forming an aluminum evaporation layer on, for example, the surface of a PET film, and forming a semiconductor coating on the obtained surface, and is rotary driven at the same peripheral velocity as the photoconductor drum 20. In the color print mode, image of CMYK are transferred to the intermediate transfer body 70 in a laminated fashion. In the black-and-white print mode, an image of single color is transferred to the intermediate transfer body 70. The secondary transfer unit 80 transfers the toner image formed on the intermediate transfer body 70 to a print medium such as a paper, and the fixing unit 90 fixes the toner image transferred onto the print medium to the medium to obtain a permanent image. The print medium is discharged to the outside the printer.

The cleaning unit 75 is provided between the primary transfer unit 60 and the charging unit 30, and has a cleaning blade 76 abutting on the surface of the photoconductor drum 20 constantly. The developer (toner) remaining on the photoconductor drum 20 after the first transfer is removed by the cleaning blade 76. The removed developer is accumulated in the cleaning unit 75 having the cleaning blade 76.

Each of the developing units 51 to 54 is detachable to the developing device 50, and is provided with a storage medium, e.g. noncontact nonvolatile memory, for storing color information, information on the remaining amount of developers, information of the number of print pages on the past, and the like such that the printer can recognize the condition of the mounted developing units. Further, after the power is started up, or after the developing units are mounted on the developing device, the information in the nonvolatile memories of the developing units is read out. In addition, the information on the remaining amount of developers and the information on the number of print pages are updated to the nonvolatile memories of the developing units after development.

As shown in FIG. 1, once the developing units 51 to 54 for a color black are mounted on all of the mount positions of the developing device 50, the color information is read from the nonvolatile memories of the four developing units, and the control unit 100 judges that the print mode is the black-and-white print mode. Moreover, when the CMYK developing units are mounted on the mounting positions of the developing device 50, the color information is read from the nonvolatile memories of the four developing units in a similar way, and the control unit 100 judges that the print mode is the color print mode. In either print mode, the amount of developers used at the time of printing is obtained, and the information on the remaining amount of toner of each developing unit is updated on the basis of the amount of developers used, and stored in each nonvolatile memory. Further, the print pages are obtained, the information on the past print pages for each developing unit is updated, and stored in each nonvolatile memory.

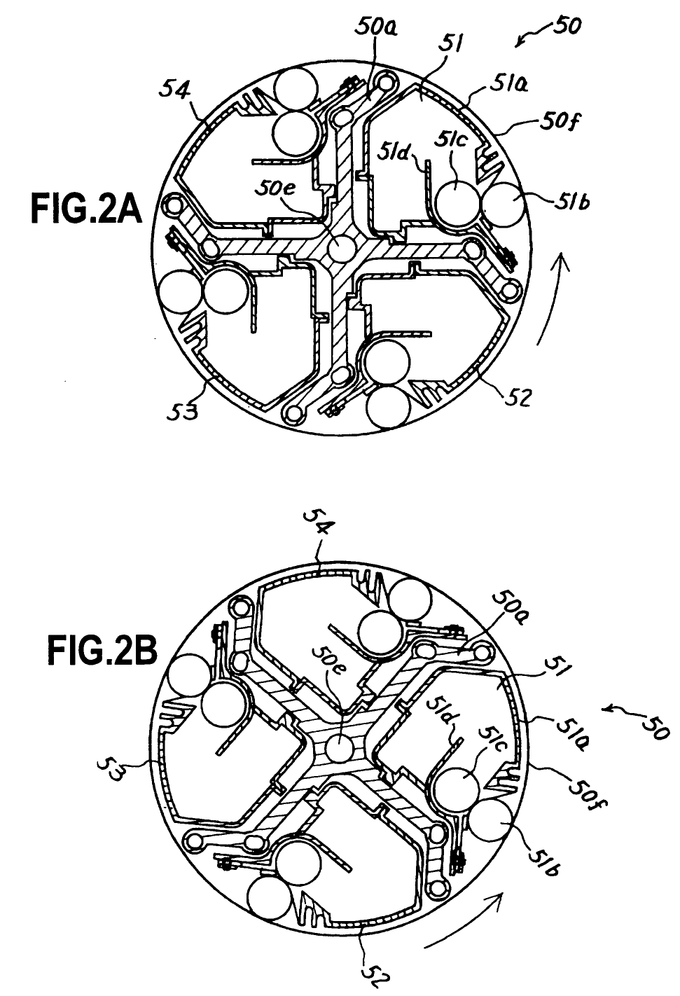

FIGS. 2A and 2B are a cross sectional views showing a detailed structure of a developing device 50. FIG. 2A is a configuration diagram showing the development device 50 in a development position, and FIG. 2B is a configuration diagram showing the developing device 50 in a queue position. According to FIG. 2A, the developing device 50 detachably mounts the plurality of developing units 51 to 54 in the space between a housing 50f and the mount portion 50a rotated with respect to the central axis 50e as the center. The plurality of developing units all have the same structure. For example, the developing unit 51 is equipped with a container 51a, developing roller 51b, feed roller 51c, and partition plate 51d. The developing roller 51b and the feed roller 51c are rotatably attached to the container 51a, and are rotated by a motor, which is not shown, when the developing units are brought proximate to the photoconductor drum 20. The feed roller 51c is rotated by being welded to the developing roller 51b with pressure, whereby the surrounding toners are subjected to abrasion charge, and the charged toners are fed to the photoconductor drum 20 via the developing roller 51b. The partition plate 51d is provided such that it surrounds the feed roller 51c, and divides a toner-containing space inside the container 51a into right and left. By providing the partition plate 51d, the toners in the space on the feed roller 51c side are fed to the developing roller 51b side by welding rotations of the feed roller 51c and the developing roller 51b. Moreover, when the developing device 50 is rotated 90 degrees counterclockwise twice, i.e. 180 degrees, the developing device 50 is positioned in the developing unit 53 as shown in FIG. 2A, and the toners inside the containing space on the feed roller 51c side are mixed at the upper part of the partition plate 51c with the toners in the containing space on the side opposite to the feed roller 51c. When the developing device 50 is further rotated 90 degrees, the mixed toners are stirred and freshened. When the developing device 50 is further rotated 90 degrees, some of the toners that are stirred and freshened are stored in the containing space on the feed roller 51c side. In this manner, since the toner-containing space is divided by providing the partition plate 51, and the feed roller is provided in one side in the toner-containing space, the toners which are subjected to abrasion charge are stirred and freshened in the toner containing space by the rotations of the developing device 50. Therefore, it is not necessary to provide toner stirring means in the developing unit, thus the developing unit can be miniaturized.

FIG. 2A shows a state in which the developing unit 51 is in the development position. Specifically, as will be described hereinafter, the developing roller 51b of the developing unit 51 used in development is brought proximate to the photoconductor drum, which is not shown, when development is carried out. On the other hand, FIG. 2B shows a state in which the developing unit 51 is in the specified queue position. Alternatively, FIG. 2B also shows a state in which the developing unit 52 is in the specified queue position, and is a figure where FIG. 2A is rotated 45 degrees clockwise. In the queue state of FIG. 2B, the developing unit 51 is in a position which is most proximate to the development position. Thus, when the developing device 50 is rotated counterclockwise, the developing unit 51 can reach the development position (position of the developing unit 51 in FIG. 2A) faster than any of the four developing units 51 to 54. Moreover, in the queue state of FIG. 2B, the developing unit 52 is in a state in which the toner therein is best stirred. Thus, when the developing device 50 is rotated counterclockwise, the developing unit 52 can reach the development position faster than any of the four developing unit 51 to 54, in the shortest moving distance and in a state where the toner thereof is in the best condition. Although the developing unit 51 is proximate to the development position, the toner thereof is not stirred, thus the condition of the toner is not optimum. In order to improve the condition of the toner, the developing unit 51 has to reach the development position after being rotated once and passing through the position of the developing unit 52, thus the moving distance of the developing unit becomes extremely long.

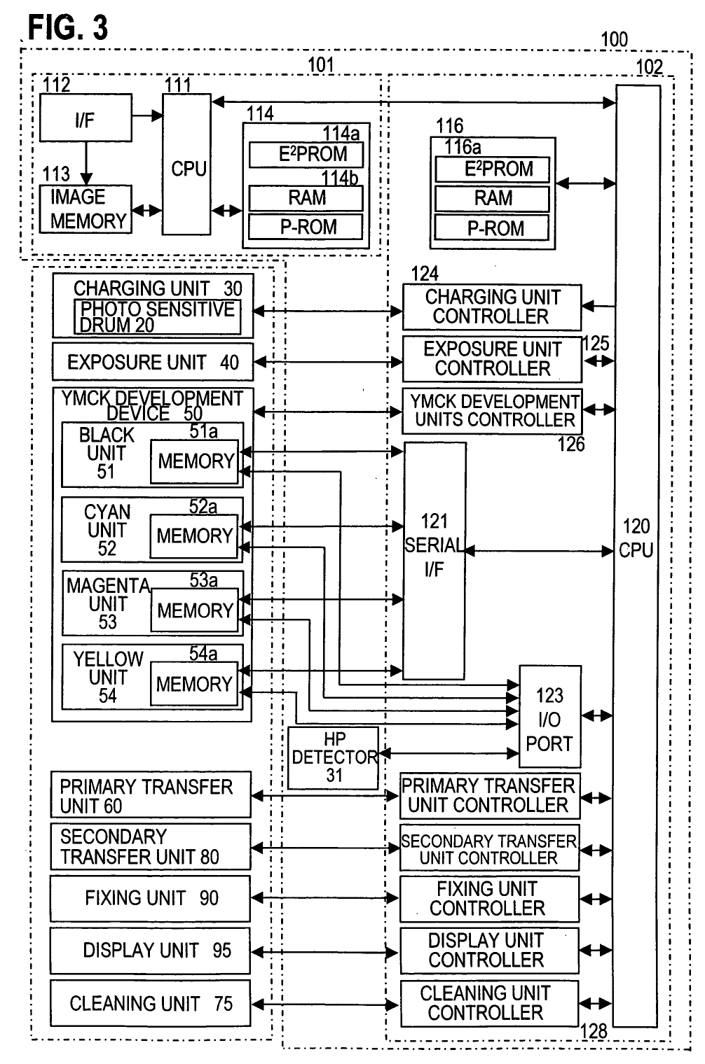

FIG. 3 is a block diagram of the control unit 100 according to the present embodiment. The control unit 100 as the control means is supplied with print job data from the host computer to perform predetermined image processing, generates a control signal and an image signal to an engine, and comprises a main controller 101 which performs display control on a display panel 95, and an engine controller 102 which controls each unit of the print engine. The main controller 101 comprises an interface 112 which receives the print job data from the host computer, an image memory 113 which stores image data present in the print job data, a CPU 11 which performs image processing such as half tone processing, setting and auto-detect of a display mode, display control of a display panel and the like, and a memory unit 114 having a nonvolatile memory 114a, and RAM, ROM 114b. Print mode information which indicates whether the printer is in the color print mode or black-and-white print mode is stored in the nonvolatile memory 114a. The print mode is judged by the main controller 101 in accordance with the color information from the memories of the developing units mounted on the developing device when the power is ON. The judged print mode information is written into the nonvolatile memory 114a.

Moreover, the engine controller 102 comprises, in addition to a CPU 120, a memory unit 116, serial interface 121, input/output port 123, drive control circuits 124, 125 and 126 which drive the charging unit 30, exposure unit 40, developing device 50 respectively, and a drive control circuit group 128 which drive the primary transfer unit 60, secondary transfer unit 80, fixing unit 90, display unit 95, and cleaning unit 75 respectively. Further, a detection portion 31 for detecting a home position of the developing device 50 is provided. The engine controller 102 is supplied from the main controller 101 with a control signal for controlling printing process and an image signal for controlling irradiation of an exposure beam, and controls each unit.

In addition, the developing units 51 to 54 mounted on the developing device 50 have developing unit side memories 51a to 54a respectively. These memories are constituted by nonvolatile memories such as FeRAM, EEPROM and the like, and store attribute information, such as color information of the developers, information on the remaining amount of developers, ID information of the developing units, information on the number of print pages developed by the developing units on the past. When the power is ON or when a developing unit is replaced or additionally mounted, the engine controller 102 accesses these developing unit side memories 51a to 54a to read the information on whether a developing unit is mounted, the color information, ID information, information on the remaining amount of developers, information on the number of print pages on the past, and the like. Further, during the development process, the information on the remaining amount of developers or the information on the number of print pages on the past is updated to the memory of the developing unit in which the development process is finished.

In a nonvolatile memory 116a in the memory unit 116, stored being information on whether or not the developing units are mounted on the four mounting positions in the developing device, the color information of the mounted developing units, ID information, information on the remaining amount of developers, information on the number of print pages on the past, and the like. Further, the nonvolatile memory 116a has stored therein a control parameter for engine control, control parameter (exposure strength, charge potential value etc.) corresponding to each developing unit, color or black-and-white print mode information, and the like. The memory unit 116 is provided with a program ROM and RAM. An engine control program, calibration control program and the like are stored in the program ROM. The CPU 120 refers to the control parameter of the nonvolatile memory 116a to execute the engine control program, thereby executing a normal printing operation. The CPU 120 executes a developing unit management program to manage the developing unit to be used for a print job.

In the present embodiment, the control unit 100, preferably the engine controller 102 executes a developing unit management program to determine which developing unit among the plurality of the developing units is used to execute development, in response to a print request outputted corresponding to a print job. Such selection of a developing unit is carried by means of various algorithms. In the first algorithm, the developing unit which is mounted first is prioritized and used. According to this algorithm, if the developer of the developing unit mounted first is consumed, a developing unit which is mounted next is used. Therefore, if the developer in the first mounted developing unit becomes empty or nearly empty when a printing operation (mainly a development process) or a certain print job is finished, the developing rotary 50 rotationally moves the secondly mounted developing unit to the queue position, in preparation for the next print job.

According to the second algorithm, if one developing unit is used for a predetermined period of time or for a predetermined number of print pages, it is switched to another developing unit. In this manner, it is possible to eliminate a developing unit which is not used for a long period of time by periodically switching the developing units, and to prevent generation of banding on a developed image due to a place of pressure welding between the feed roller 51c and developing roller 51b of the developing unit which is not used for a long period of time. This fact is described in Japanese Patent Application No. 2004-66150 in detail. According to this algorithm, if a developing unit, which is currently in use, completes a developing operation for a predetermined period of time or of a predetermined number of pages at the point of time when the printing operation (mainly the development process) for a certain print job is ended, the developing rotary 50 rotationally moves another developing unit to the queue position in preparation for the next print job.

According to a third algorithm, the developing units are used for development, starting from a developing unit having the largest amount of the remaining developer. According to this algorithm, if the remaining amount of developer of a developing unit, which is in use, becomes less than the remaining amount of developer of any of the other developing units at the point of time when a printing operation of a certain print job is finished, the developing unit with the largest amount of the remaining developer is rotationally moved to the queue position in preparation for the next print job.

Various algorithms other than the above-described algorithms can be considered. In either case, the engine controller 102 uses the plurality of mounted developing units of the same color by switching them accordingly in accordance with a predetermined algorithm.

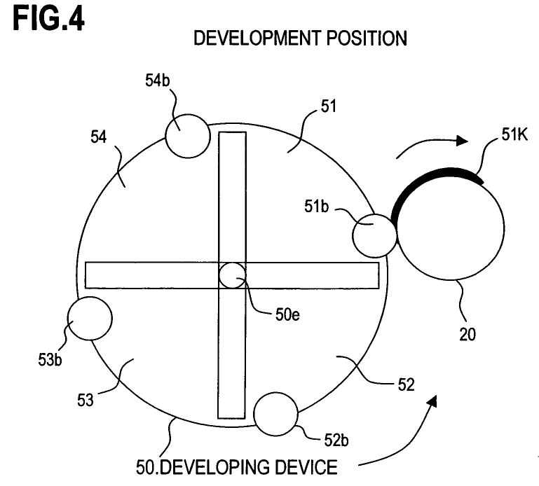

FIG. 4 is a figure showing a development position of the developing device (developing rotary) 50. In FIG. 4, the developing unit 51 is in a development position. Specifically, the developing roller 51b of the developing unit 51 is brought approximately to the photoconductor drum 20, and a developer 51K is fed to the surface of the photoconductor drum 20 from the developing roller 51b.

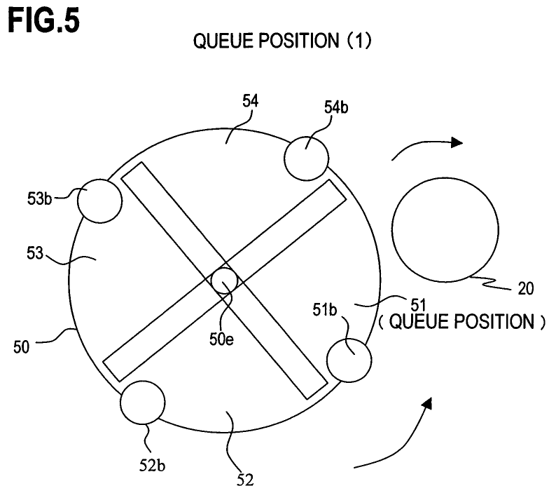

FIG. 5 is a figure showing a first queue position of the developing device (developing rotary) 50. In FIG. 5, the developing unit 51 is in a queue position. In this queue position, the developing rollers 51b to 54b are separated from the photoconductor drum 20, and in the case of a counterclockwise rotation, the developing unit 51 is in a position which is most proximate to the development position. Therefore, by moving the developing unit 51 to a the specified queue position as in FIG. 5 and allowing it to queue for the next print job, when a print request corresponding to the next print job is outputted, the developing unit 51 can be moved to the development position faster than any other developing units in the shortest amount of time.

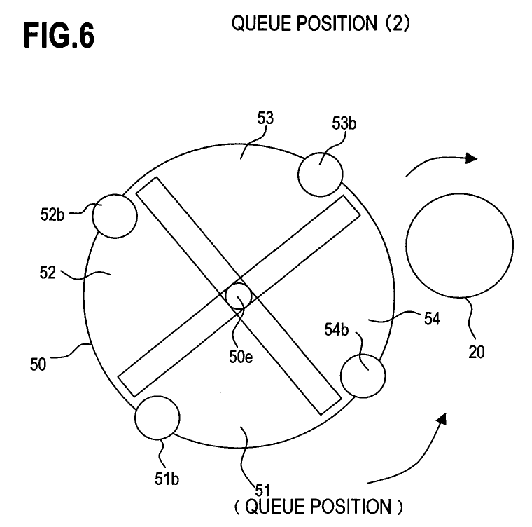

FIG. 6 is a figure showing a second queue position of the developing device (developing rotary) 50. In FIG. 6, the developing unit 51 is in a queue position. In this queue position, the developing rollers 51b to 54b are separated from the photoconductor drum 20, and, as shown in FIG. 2B, the developer in the developing unit 51 is best stirred. Therefore, the developer can be kept in the best condition for the next print job. In order to keep the developer in the developing unit in a suitable condition, it is necessary to mix and stir the charged developer on the feed roller side from the partition plate in the developing unit, and the developer on the other side which is not charged. However, in order to stir the developer, as described in FIG. 2, it is necessary to rotate the developing device 50 and move it to the position of the developing unit 51 of FIG. 6. By allowing the developing unit 51 to queue in a state where the developer is stirred as above, the developing unit 51 with the developer in the best condition can be moved to the development position with shorter time in response to a print request corresponding to the next print job. If queuing in the positions of the developing units 52, 53 and 54, it means that the developer is not stirred, thus it is necessary to move the developing units to the position of the developing unit 51 to stir the developer, and further to rotationally move same to the developing position.

Moreover, the development position shown in FIG. 4 can be the specified queue position. By allowing the developing device 50 to queue in the development position, a print operation can be started immediately without rotating the developing roller, in response to a print request corresponding to the next print job.

The position in FIG. 4, the specified queue position in FIG. 5, or the specified queue position in FIG. 6 can be selected depending on selecting to minimize the distance of rotational movement by move the developing unit to the position which is most proximate to the development position, or selecting to reduce the moving distance to the development position while keeping the developer in the best condition.

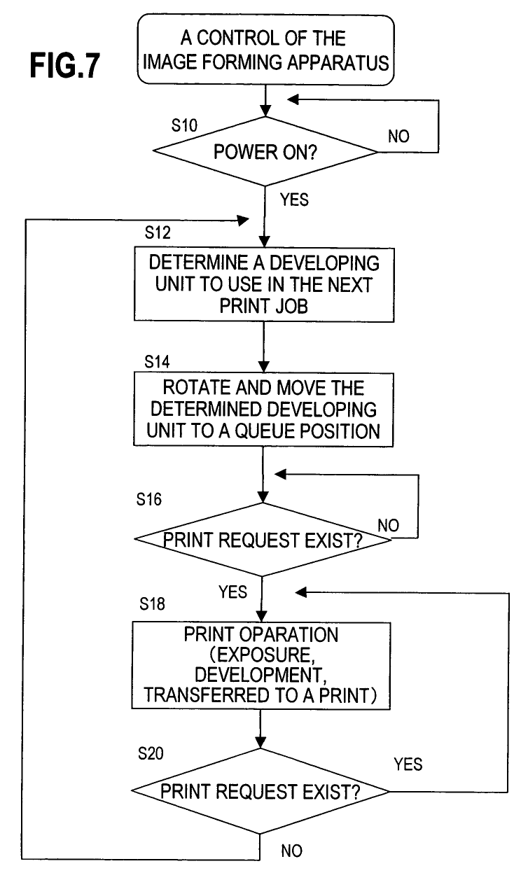

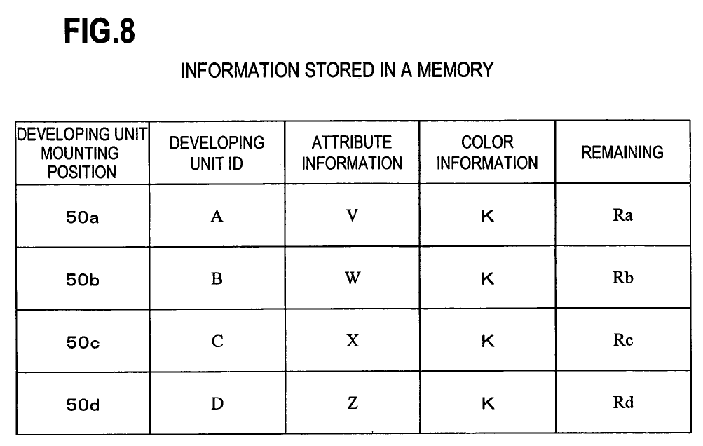

FIG. 7 is a flow chart showing a control process of the image forming apparatus in the present embodiment. In the image forming apparatus of the present embodiment, when the power is turned on (S10), as an initialization operation the engine controller 102 accesses a nonvolatile memory of a mounted developing unit, reads out the stored information, and stores the information in the nonvolatile memory 116a in the controller. FIG. 8 is a figure showing the information stored in the nonvolatile memory. As shown in FIG. 8, in accordance with the mounting position of the developing rotary, attribute information such as ID information, color information, and information on the remaining amount of developer of the developing unit, and a mounting time, developing time, the number of development pages, etc are stored.

Further, as the initialization operation, a CPU of the engine controller 102 executes the developing unit management program to determine a developing unit to use in the next print job (S12). This algorithm for determination is as described above, wherein the next developing unit is determined based on the information on the remaining amount and other attribute information. The engine controller 102 then rotates the developing rotary 50 and moves the determined developing unit to a queue position (S14). Accordingly, the developing unit to be used is allowed to queue in the specified queue position in preparation for the next print job. The specified queue position is as described in FIGS. 5 and 6. In this manner, in the initialization operation the developing unit to be used in the next job is moved to the specified queue position and allowed to queue.

Next, a print request is outputted from a main controller 101 in accordance with a print job (S16), in response to which the engine controller 102 executes an engine control program to control a print operation (S18). In control of a print operation, the developing rotary 50 is rotationally controlled, and the developing unit which queues in the specified queue position is rotationally moved to the development position. However, if the developing unit queues in the development position, rotational movement is not necessary. Then, a latent image is formed on the photoconductor drum 20 by means of an exposure process, the developer is fed from the developing unit to perform development, and a toner image obtained by the development is transferred to a print medium. This printing operation S18 is executed in succession as long as a print request is outputted from the main controller 101 (S20).

When there is no longer a series of print request corresponding to print jobs (NO in S20), the CPU of the engine controller 102 executes the developing unit management program to determine a developing unit to be used in the next print job on the basis of a predetermined algorithm for determination (S12). The engine controller 102 then rotates the developing rotary 50 and moves the determined developing unit to a specified queue position to allow it to queue (S14). As above, when a print operation for a print job is finished, a developing unit to be used in the next print job is moved to the specified queue position and allowed to queue. Accordingly, when a print request corresponding to the next print job is outputted, the developing unit queuing in the specified queue position is moved to the development position so that a printing process can be executed immediately, and the printing time can be reduced. Alternatively, a developer in the best condition can be used to start the printing process in a short amount of time.

When the photoconductor drum is replaced in a state where the developing unit queues for a print request for the next print job (S16), calibration using a pattern with patches is executed on the photoconductor drum in order to determine the most suitable control parameter. Specifically, the developing unit is moved to the development position, a specified pattern with patches is developed on the surface of the photoconductor drum, the optical concentration thereof is detected, and a control parameter, such as the most suitable exposure strength, charge bias potential and the like, is determined. Therefore, the developing unit is rotationally moved by this calibration. In the present embodiment, the steps S12 and S14 are executed in the initialization operation involving this calibration, to move the developing unit to be used in the next print job to the specified queue position.

Also, when the developing unit is replaced or newly mounted in a state where the developing unit queues for a print request for the next print job (S16), calibration is executed on the developing unit for the same reason as described above. For this calibration, the mounted developing unit is moved to the development position, and the development process is carried out. In the present embodiment, the steps S12 and S14 are executed in the initialization operation involving this calibration, to move the developing unit to be used in the next print job to the specified queue position.

In addition to this, when the position of the developing unit is moved or when it has to be moved, it is preferred that a developing unit to be used next time be moved to the specified queue position to allow it to queue for the next print job.

As above, in the black-and-white print mode where the plurality of developing units of the same color are mounted, at the point of time when a print job is finished, when the power is turned on, or at the point of time of other initialization operations, the developing unit to be used in the next job is moved to the specified queue position and allowed to queue. Accordingly, the printing process can be started for the next print job in a short amount of time. Alternatively, a developing unit in which the developer is in the best condition can be used for the printing process.

According to the present embodiment, in the color print mode in which a plurality of developing units of colors of CMYK are mounted in the developing device 50, it is preferred that the developing unit, which has a color for development used first in the color printing process, be moved to the above-described specified queue position and allowed to queue for the next print job. For example, when the printing process is executed in the order of KMCY, the black K developing unit is moved to the specified queue position shown in FIG. 6 and allowed to queue in the initialization operation or at the point of time when the print job is finished. By allowing the developing unit to queue in this position, the black developing unit in the best condition can be moved to the development position in a short amount of time to immediately start the printing process of black.

The above embodiments have described that the specified queue position includes either the position which is most proximate to the development position, or the position in which the developer is kept in the best condition. However, a specified queue position, which is most proximate to the development position and in which the developer can be kept in the best condition, can be realized by changing the positional relationship between the photoconductor drum and the developing device. In this case, of course, it is preferred that the developing unit to be used in next print job to the specified queue position and allowed for the next print job.

1. An image forming apparatus, comprising:
an image supporting body in which a latent image is formed;
a developing device which is mounted detachably with a plurality of developing units storing developers of the same color and which can move the developing units to a plurality of positions; and
control unit for controlling a printing operation for adhering the developer of the developing unit on a development position onto a latent image of the image supporting body to perform development in response to a print request,
wherein, after finishing the printing operation using a first developing unit in accordance with a print job, the control unit moves a second developing unit used in the next print job to a specified queue position among the plurality of positions, to maintain the second developing unit in a queuing state.

2. The image forming apparatus according to claim 1, wherein, in an initialization operation at the time of turning on a power or of predetermined initialization, the control unit moves a second developing unit used in the next print job to a specified queue position among the plurality of positions, to maintain the second developing unit in a queuing state.

3. An image forming apparatus, comprising:
an image supporting body in which a latent image is formed;
a developing device which is mounted detachably with a plurality of developing units storing developers of the same color and which can move the developing units to a plurality of positions; and
control unit for controlling a printing operation for adhering the developer of the developing unit on a development position onto a latent image of the image supporting body to perform development in response to a print request,
wherein, in an initialization operation at the time of turning on a power or of predetermined initialization, the control unit moves a second developing unit used in the next print job to a specified queue position among the plurality of positions, to maintain the second developing unit in a queuing state.

4. The image forming apparatus according to claim 1, wherein the specified queue position is the development position in which the second development unit is placed, or a queue position which is most proximate to the development position in which the second development unit is placed.

5. The image forming apparatus according to claim 1, wherein the specified queue position is a position in which the developer stored in the second developing unit is stirred.

6. The image forming apparatus according to claim 1, wherein the control unit determines the second developing unit based on a predetermined algorithm, and uses the plurality of developing units by sequentially switching the plurality of developing units.

7. The image forming apparatus according to claim 2, wherein the time when the predetermined initialization is performed includes when calibration is performed after replacing a photoconductor drum, or when calibration is performed after a developing unit is replaced or newly mounted.

8. The image forming apparatus according to claim 2, wherein the specified queue position is the development position in which the second development unit is placed, or a queue position which is most proximate to the development position in which the second development unit is placed.

9. The image forming apparatus according to claim 2, wherein the specified queue position is a position in which the developer stored in the second developing unit is stirred.

10. The image forming apparatus according to claim 2, wherein the control unit determines the second developing unit based on a predetermined algorithm, and uses the plurality of developing units by sequentially switching the plurality of developing units.

11. The image forming apparatus according to claim 3, wherein the specified queue position is the development position in which the second development unit is placed, or a queue position which is most proximate to the development position in which the second development unit is placed.

12. The image forming apparatus according to claim 3, wherein the specified queue position is a position in which the developer stored in the second developing unit is stirred.

13. The image forming apparatus according to claim 3, wherein the control unit determines the second developing unit based on a predetermined algorithm, and uses the plurality of developing units by sequentially switching the plurality of developing units.

14. The image forming apparatus according to claim 3, wherein the time when the predetermined initialization is performed includes when calibration is performed after replacing a photoconductor drum, or when calibration is performed after a developing unit is replaced or newly mounted.
